(19) United States
(12) Patent Application Publication
(10) Pub. No.: US 2024/0308345 A1
(43) Pub. Date: Sep. 19, 2024

(54) METHOD OF MONITORING THE OPERATION OF A WORK VEHICLE HAVING A WORK IMPLEMENT AND A DISPLAY DEVICE

(71) Applicant: Deere & Company, Moline, IL (US)

(72) Inventors: Andrew L. Noll, Dubuque, IA (US); Hanna J. Wickman, Grimes, IA (US); Joy Vuijk, Johnston, IA (US); Jenna L. Rettenberger, Dubuque, IA (US)

(21) Appl. No.: 18/439,317

(22) Filed: Feb. 12, 2024

Related U.S. Application Data
(60) Provisional application No. 63/489,847, filed on Mar. 13, 2023.

(51) Int. Cl. B60K 35/81; B60K 35/22; B60K 35/28; G06F 3/04817; G06F 3/0482; G06F 3/0484

(52) U.S. Cl. CPC B60K 35/81; B60K 35/22; B60K 35/28; G06F 3/04817; G06F 3/0482; G06F 3/0484; B60K 2360/115; B60K 2360/119; B60K 2360/1438; B60K 2360/188; B60K 2360/61

(57) ABSTRACT

A system and method of monitoring the operation of a work vehicle having a work implement and using a display device with a display. The method includes displaying on the display device a display field; displaying within the display field a graphical user interface including an application launcher icon; launching a run page within the graphical user interface upon selecting the application launcher icon; and displaying within the run page a first overlay, a second overlay, and a header ribbon. The first overlay and second overlays covers a first portion and second portion of the run page, respectively, with a header positioned adjacent to one the overlays and a predetermined application icon cluster. Upon selecting icon from predetermined application icon cluster, the display field displays a third running application covering the first section, and automatically updates the second section or the predetermined application icon cluster.

### CROSS-REFERENCE TO RELATED APPLICATIONS

This claims priority U.S. Application No. 63/489,847 titled “Method of Monitoring the Operation of a Work Vehicle having a Work Implement and a Display Device”, filed on Mar. 13, 2023, which is hereby incorporated by reference in its entirety.

### FIELD OF THE DISCLOSURE

The present disclosure relates to a work vehicle having a work implement, and more particularly to a system and method for controlling and maintaining the operation of the work vehicle within a display controller.

### BACKGROUND

Work vehicles include display devices that display vehicle information including vehicle control functions, vehicle operations, vehicle operating characteristics, vehicle operating statistical information, and vehicle maintenance information. The display device is located in the cab of the vehicle and is accessible by the vehicle operator to review current vehicle conditions, current environmental conditions, or to select from a variety of operations that are selectable by the operation to be performed. In some display devices, each of the selectable operations are displayed on a touch screen which the operator selects to start a vehicle operation, review a current operating condition of the vehicle, or to review environmental inputs surrounding the vehicle. As operations, and diagnostics become more sophisticated, the number of selectable options presented on the vehicle display that are selected by an operator increase. Because of the access of the large amount of information by an operator, the organization of the large amounts of information to be readily accessible by an operator has become more difficult. What is needed therefore is a display control device having display features that reduce the complexity of display information, while still presenting to an operator all of the relevant vehicle features and functions to efficiently and effectively operate the work vehicle.

### BRIEF DESCRIPTION OF THE DRAWINGS

FIG. 1A illustrates a work vehicle which of at least one exemplary embodiment as implemented.

FIG. 1B illustrates a graphical diagram of the system of a vehicle according to an exemplary embodiment.

FIG. 2 is an exemplary embodiment of a display field on a touch screen display with application launcher icons shown as tiles.

FIG. 3 is a flowchart representing an exemplary method according to the present disclosure monitoring the operation of a work vehicle having a work implement and a display device.

FIG. 4 is a flowchart representing an exemplary method according to the present disclosure for monitoring and visualizing a plurality of metrics during operation of a work vehicle an implement and a display device.

FIGS. 5A-5C are exemplary embodiments of an overlay in an extended run page according to the method shown in FIG. 4, detailing details of a parameter.

FIG. 6 is an exemplary embodiment of overlay in a first portion, an overlay in a second portion, and a header ribbon in a grade control run page according to the method in FIG. 3.

### DETAILED DESCRIPTION

Various example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms a processor specifically programmed to execute software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of example embodiments are typically encoded on some form of tangible (or recording) storage medium or implemented over some type of transmission medium. The tangible storage medium may be magnetic (e.g., a floppy disk or a hard drive) or optical (e.g., a compact disk read only memory, or “CD ROM”), and may be read only or random access.

The term implement 65 may refer to a particular piece of equipment or function of the vehicle including a blade, bucket, auger, plow, to name a few.

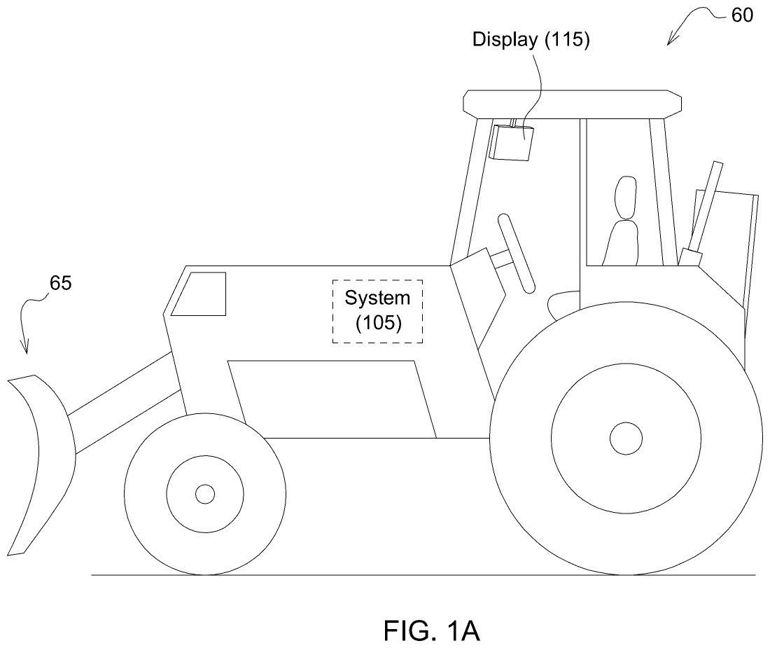

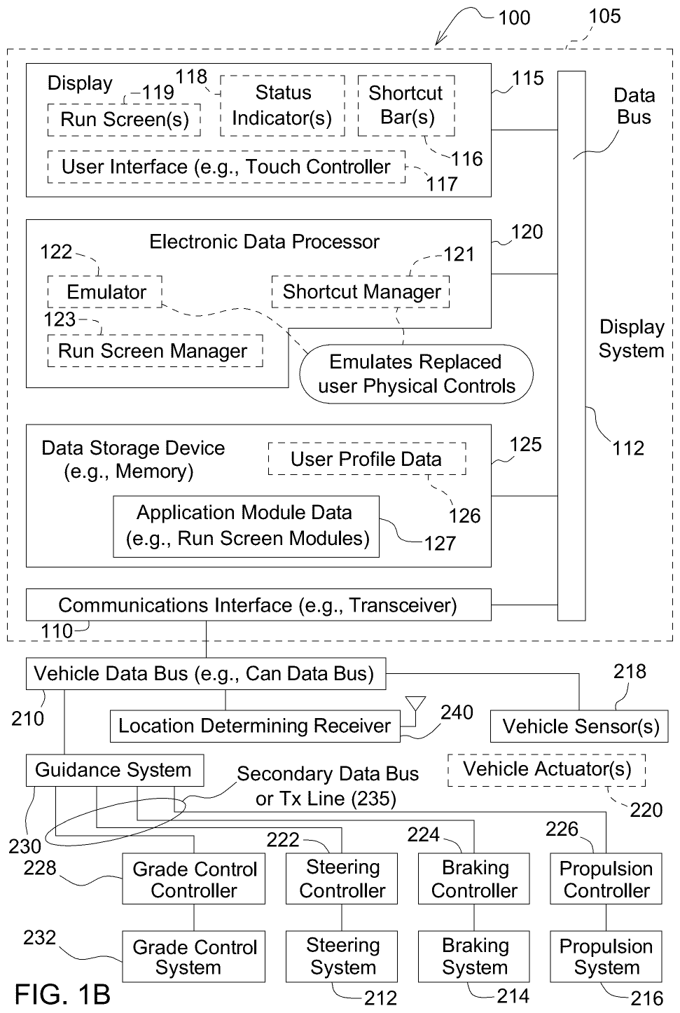

FIG. 1A illustrates a vehicle 60 in which at least one example embodiment is implemented. The vehicle 60 includes a display system 105 including a display 115. The vehicle may be a work vehicle such as an off-road work vehicle, agricultural machine, forestry machine, construction machine or heavy equipment vehicle. However, example embodiments are not limited thereto and may be implemented in other types of vehicles.

FIG. 1B illustrates one exemplary system implemented on a work vehicle. The display 115 may display any features or parameters of the vehicle 60, including, for example, speed, grade control, payload weighing, heading information, grade control systems, camera views, object detection, worksite map. The display 115 may be used to enter user preference parameters described in further detail below. For example, the display 115 may be used to establish a retracting shortcut bar, status shortcuts and edit run page sets.

The system 100 of FIG. 1B includes electronic modules, software modules, or both. The system 100 includes a display system 105 to support storing, processing or execution of software instructions of one or more software modules to be displayed on a ruggedized screen or monitor that provides the operator with critical information about the machine's performance, operation, diagnostics, and surroundings. Data associated with a machine's performance comprises of a real-time information about engine speed, fluid temperatures, hydraulic system pressure, fuel levels, and other vital operating parameters. Other features may include guidance and auto-steering data to display guidance lines, GPS information and automated steering status; camera feeds; diagnostic codes; grade control for setting the depth, speed and angle of an implement 65; telematics for remote monitoring, fleet management, and data transfer; and the user interface 117 for machine control. The display system 105 is indicated by the dashed lines in FIG. 1B. It should be understood that the system 100 may include other systems configured to support the storing, the processing of or the execution of software instructions of one or more software modules in the functioning of the machine. However, for the sake of brevity, they will not be described understanding that FIG. 1B is not limited just to the features shown in FIG. 1B.

The lines that are interconnecting the aforementioned devices may be physical data paths, logical data paths, or both. Physical data paths are defined by transmission lines or data buses. Data buses may be, for example, Control Area Network (CAN) buses or ISO buses. Logical data paths may comprise logical or virtual communications that take place within software or between software modules.

The display system 105 is configured receive data regarding systems (e.g., steering system 212, braking system 214, propulsion system 216, vehicle sensor(s) 218, components and implements 65 via a communications interface 110 in the display system 105 that accesses a vehicle data bus 210. The vehicle data bus 210 may be a controller area network (CAN) data bus, for example.

The communications interface 110 may receive and transmit messages containing further data to/from the vehicle data bus 210 such as, for example, the steering system 212, braking system 214, propulsion system 216, vehicle sensor(s) 218 and grade control system 232 or other controller of the vehicle connected on the data bus. The messages may be implemented using a protocol such as CAN. The messages may contain data including operational parameters or other parameters related to the vehicle provided by the sensors 218, for example, temperature gauges, magnetic wheel speed sensors, traction control sensors, etc.

The communications interface 110 may also receive input signals from the imaging devices (not shown). The output signals from the imaging devices may be provided directly to the communications interface 110 for example via intervening components for analog-to-digital conversion and/or video interface (not shown). Certain additional sensors (not shown) may be functionally linked to the control module (also referred to as a controller) and provided to detect vehicle operating conditions and/or kinematics.

For example, vehicle kinematics sensors for tracking a position of an imaging device may be provided in the form of inertial measurement units (each, an IMU) integrated within an imaging device and/or separately mounted on at least the frame of the work vehicle 60, and further on the boom arms or other relevant component upon which the imaging device is mounted. IMUs include several sensors including, but not limited to, accelerometers, which measure (among other things) velocity and acceleration, gyroscopes, which measure (among other things) angular velocity and angular acceleration, and magnetometers, which measure (among other things) strength and direction of a magnetic field.

Other vehicle sensors functionally linked to the controller which may optionally be provided for functions as described herein or otherwise may include for example global positioning system (GPS) sensors, vehicle speed sensors, ultrasonic sensors, laser scanners, radar wave transmitters and receivers, thermal sensors, imaging devices, structured light sensors, and other optical sensors, and whereas one or more of these sensors may be discrete in nature a sensor system may further refer to signals provided from a central machine control unit.

Each of the steering system 212, braking system 214, propulsion system 216 and grade control system 232 receives commands from and communicates data to a steering controller 222, braking controller 224, propulsion controller 226, and grade control controller 228, respectively.

The steering system 212 cooperatively operates with the steering controller 222 to control the steering of the vehicle. For example, if a user of the vehicle selects a certain track (route) to follow, the steering controller 222 receives commands from a guidance system 230 and controls the steering system 212 such that the vehicle follows the selected route. Moreover, the steering controller 222 may control the steering system 212 in a conventional manner when a user is manually driving. The steering system 212 may be an electrical steering system, a drive-by-wire steering system, an electro-hydraulic steering system, or a hydraulic steering system with an electronic control interface, for example.

The vehicle data bus 210 provides signals to the steering controller 222 from the display system 105. For example, the vehicle data bus 210 may provide signals including CAN messages to the steering controller 222. The messages may include, for example, commands such as steering angle commands or position data.

The braking system 214 cooperatively operates with the braking controller 224 to control the braking of the vehicle. For example, if a user of the vehicle selects a certain track (route) to follow, braking controller 224 receives commands from the guidance system 230 and controls the braking system 214 to brake when the vehicle is approaching a turn. Moreover, the braking controller 224 may control the braking system 214 in a conventional manner when a user is manually driving.

The propulsion controller 226 cooperatively operates with the propulsion system 216 to control the propulsion of the vehicle. The propulsion may be any known motor or engine, for example. For example, if a user of the vehicle selects a certain track (route) to follow, propulsion controller 226 receives commands from the guidance system 230 and controls the propulsion system 216 to move the vehicle along the selected route. Moreover, the propulsion controller 226 may control the propulsion system 216 in a conventional manner when a user is manually driving.

The grade control controller 228 cooperatively operates with the grade control system 232 to control the positioning of the implement 65 relative to the frame of the vehicle during grading operations. For example, if a user of the vehicle selects a certain depth for the implement 65 (e.g. a blade) to cut away on a surface, the grade control controller 228 receives commands from the grade control system 232 to command the pitch, roll and, yaw movement of the implement 65. Moreover, the grade control controller 228 may control the grade control system 232 in a conventional manner when a user is manually operating the implement 65.

As described above, the steering controller 222, braking controller 224, propulsion controller 226 and the grade control controller 228 communicate with the guidance system 230. The steering controller 222, braking controller 224 and propulsion controller 226 may communicate with the guidance system 230 through a secondary data bus or transmission line 235. The guidance system 230 provides information to the steering controller 222, braking controller 224, propulsion controller 226 and grade control controller 228 regarding location and route. Moreover, the guidance system 230 is connected to the vehicle data bus 210 and obtains data and commands regarding which location and route to follow, for example. The guidance system 230 may be a Global Positioning System (GPS) system or another type of guidance system.

The guidance system 230 may automatically steer the vehicle in accordance with a path plan (e.g., linear path or contour) based on GPS position measurements or navigation system measurements.

A location determining receiver 240 is connected to the vehicle data bus 210, as well. The location determining receiver 240 may be a GPS receiver, for example. The location determining receiver 240 transmits the location to the display system 105 and guidance system 230 through the vehicle data bus 210. The location-determining receiver 240 may provide one or more of the following data types: position data (e.g., expressed as geographic coordinates), velocity data, and acceleration data. Velocity data further comprises speed data and heading data for the vehicle. The location determining receiver 240 transmits the data to the display system 105 and guidance system 230 through the vehicle data bus 210. The data may further be displayed on the display 115 of the display system 105.

The vehicle may include various actuators 220. For example, an electrical steering system or a drive-by-wire steering system may include an electric motor or actuator that is mechanically coupled to rotate or steer at least one wheel of the vehicle.

As described, the display system 105, transmits and receives data regarding the vehicle through the communications interface 110. The communications interface is connected to a data bus 112. In addition to the communications interface 110, the display 115 and the data bus 112, the display system 105 further includes a processor 120 and a data storage device 125.

The communications interface 110, the display 115, the data bus 112, the processor 120 and the data storage device 125 are connected to the data bus 112 and are configured to communicate through the data bus 112.

The processor 120 implements algorithms and other functionality of the display system 105 described in further detail below.

The processor 120 may be any type of processor configured to execute program codes such as those stored in the data storage device 125.

In one embodiment, the processor 120 may include an electronic data processor, a digital signal processor, microprocessor, a microcontroller, a programmable logic array, a logic circuit, an arithmetic logic unit, an application specific integrated circuit, a digital signal processor, a proportional-integral-derivative (PID) controller, or another data processing device.

The data storage device 125 may include any magnetic, electronic, or optical device for storing data. For example, the data storage device 125 may include an electronic data storage device, an electronic memory, non-volatile electronic random access memory, one or more electronic data registers, data latches, a magnetic disc drive, a hard disc drive, an optical disc drive, or the like. The processor 120 outputs results of algorithms and other functionality of the display system 105 to the data bus 112.

The data storage device 125 may store user profile data 126 and application module data 127. The user profile data 126 may include data representing a skill level of the user and authorization level of the user. For example, the skill level may be beginner, intermediate and advanced. The application module data 127, which is Run Screen Module or software module that is dedicated or programmed to perform, monitor and/or control a certain work task (e.g., planting, seeding, spraying, harvesting, leveling, tilling) of the work vehicle, includes data for the display 115 to display run screens 128 and organizes run screens 128 according to sets, as will be described in further detail below.

The processor 120 includes a shortcut manager 121, emulator 122 and run screen manager 123. The shortcut manager 121 manages the shortcut abilities of the display 115 such as the shortcut bar 116. The emulator 122 emulates other buttons on the display 115 that were conventionally represented by physical controls. With the shortcut manager 121, the emulator 122 emulates replaced user physical controls. The run screen manager 123 retrieves run screens 128 and sets of run screens 128 based on an action of the user. Moreover, the run screen manager 123 organizes the run screen modules 127 into sets or clusters. The sets of run screen modules 127 may be dictated by a user's selection and/or programmed by a manufacturer of the display system 105, or ordered based on conditions as described below.

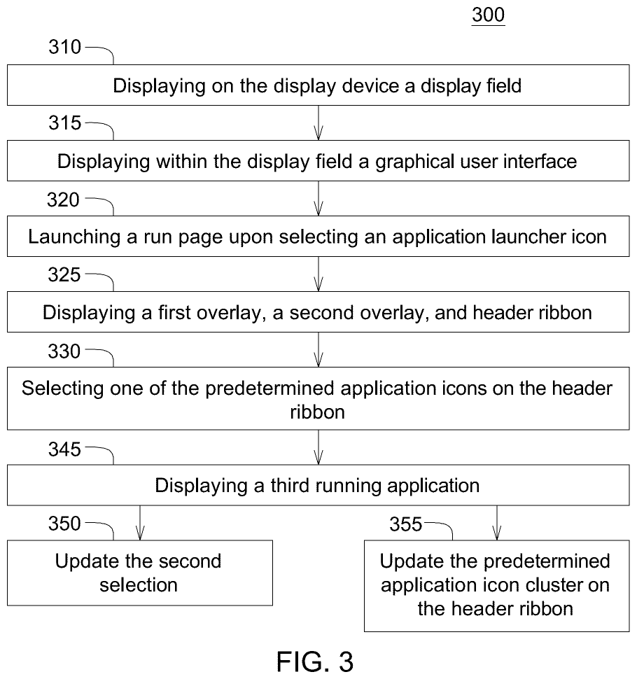

The display 115 may be a touch screen display with a user interface 117. The user interface 117 may act as a touch controller. The user interface 117 may communicate the actions of the user (e.g., touch) to the processor 120 through the data bus 112. While actions by the user are often described as touching, it should be understood that the user interface 117 may operate based on voice commands and/or other objects (e.g., stylus) touching the display. Moreover, other possible gestures include double tap, drag/slide, flick, nudge, pinch and spread. The display 115 can display a header ribbon 119, status indicator 118 and run screen 128 in the display field 116, as is illustrated in FIGS. 3, 5A-5C, and 6.

### Run Pages

The terms run pages 128, run screens and dashboards may be used interchangeably.

At least one example embodiment discloses an edit run page set overlay. The edit run page set overlay may include design components for editing a current run page set. The edit run page set overlay gives the user the ability to change the name of the current run page set and to add, remove, and reorder pages within the run page set.

A run screen 128 provides a dedicated functionality or set of functions for a machine, such as grade control, payload weighing, path planning, power source management, object detection, or other work tasks specific to the implement 65 or machine form. Further, the run screen 128 may provide diagnostics, data history, alerts or status messages on different components, systems, or its implements 65 (attached or operable connected to the machine).

Run screens 128 are customizable with modular content for the display 115 of machine status and control information. Run screens 128 have custom user-programmable controls (e.g., guidance control) for machine components, systems or features that previously required separate physical controls (e.g., joystick, dials, levers, knobs or switches). Advantageously, the work vehicle manufacturer does not need to provide physical controls for less popular or seldom ordered options on machines (e.g., front power take-off shaft) because the display system 105 can be customized to produce data messages that emulate such physical controls in communication with the machine data bus 210 (e.g., CAN data bus or ISO data bus).

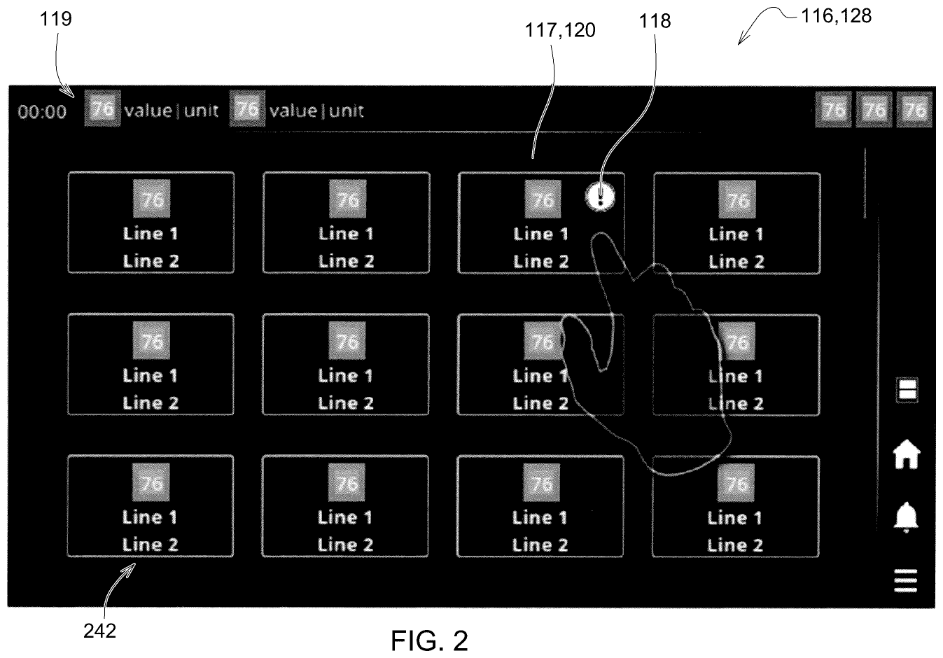

FIG. 2 discloses an exemplary embodiment of a display 115 with tiles 242 representing various applications or run screen modules 127 on the work vehicle 60. These tiles 242 may be selected and reordered through touch screen or toggling through via knobs and buttons. In the context of a display 115 with a user interface 117 design, tiles 242 may refer to small, substantially rectangular graphical elements that represent an app, a function, a specific content item, or a piece of information. Information representation provide a quick and efficient way for users to access or interact with specific elements within a display 115. Interactive elements allow users to tap, click, or interact with them to access further details, launch application, or perform specific actions. A specific content item may include information display 115 of key information or visual, such as app icons, live data feeds, notifications, or previews of content, providing users with at-a-glance insight into the associated elements. The user may reprogram the display 115 to only have controls or a prioritization of tiles 242 that are relevant to a task at hand and the particular version of the vehicle, for a particular user, or for a particular worksite operation. That is, tiles 242 associated with grade control may be prioritized during road building. Tiles 242 associated with path planning may be prioritized during street paving. Tiles 242 associated with depth control may be optimized during excavation. Tiles 242 associated with object detection application may be prioritized in crowded spaces such as residential areas. Tiles 242 associated with payload weighing may be prioritized for tracking material movement. FIG. 2 further discloses an alert (as identified by the exclamation in this embodiment) for bringing attention to an application needing attention. The alert may consist of a color change of the relevant tile(s), flashing icons, an auto reorganization of the tiles 242 on the display 115 to prioritize those function requiring attention, or a symbol as shown, as alerts to the operator. In one exemplary embodiment, a grade control management tile may flash if the implement 65 moves outside the desired grade range, thereby alerting the operator to recalibrate the system, or alternatively diagnose a root cause through error codes. In another embodiment, a telematics tile may alert an operator if a work vehicle from the fleet of work vehicles has paused operations. Another example includes diagnostic apps representing engine-related codes for low oil pressure, overheating, and exhaust issues; hydraulic system codes for out-of-range fluid temperatures, low pressure, or hydraulic overload; battery related error codes such as battery charge faults, battery health alerts, or battery disconnect; to name a few.

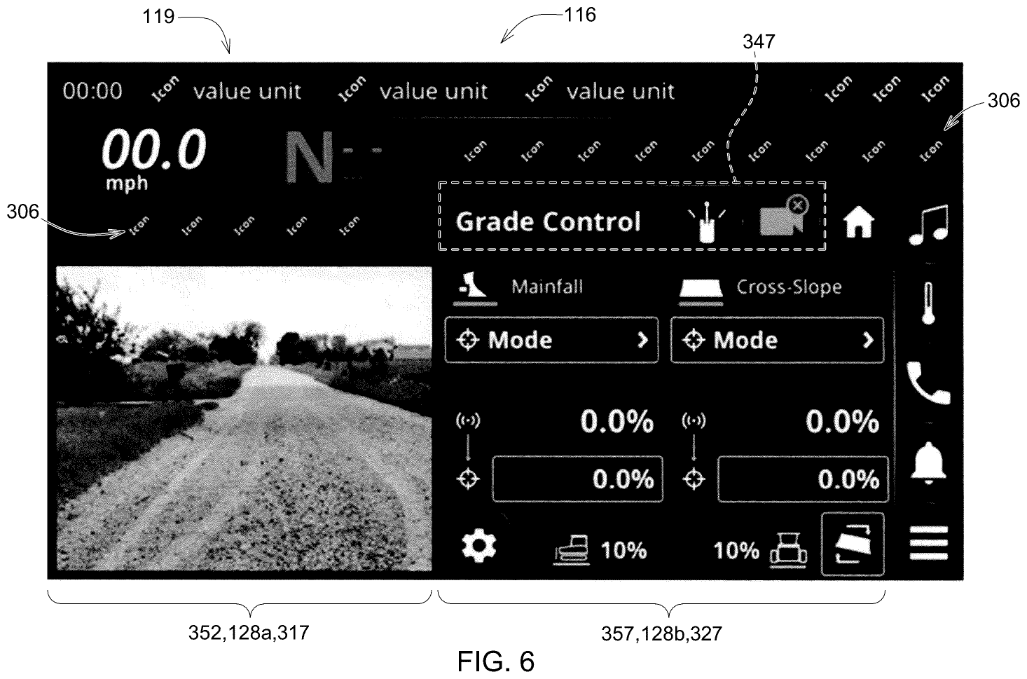

With reference to FIG. 6, FIG. 3 discloses a method 300 of monitoring the operation of a work vehicle 60 having a work implement 65 and a display device 115. In a first step 310, the method includes displaying on the display device 115 a display field 116. In step 315, the method includes displaying within the display field 116 a graphical user interface 117 including an application launcher icon 305. Then the method involves launching a run page 128 within the graphical user interface 117 upon selecting the application launcher icon 305 in step 320. FIG. 6 represents a run page 128 in a display field 116 for a grade control application. In step 325, the method includes displaying within the run page 128 a first overlay 317 shown herein as a camera view, a second overlay 327 shown here as a cluster of status indicators related to grade control such as mainfall and cross-slope, and a header ribbon 119 comprising of a cluster or set context driven application launcher icons related to the work vehicle 60. For example, an excavator may disclose have an application launcher icon for details on the relative orientation of the cab with the chassis. The first overlay 317 covers a first portion 352 of the run page 128 and includes a first currently running application. The second overlay 327 covers a second portion 357 of the run page 128 and includes a second currently running vehicle application. The header ribbon 119 is positioned adjacent to one or more of the first overlay and the second overlay, wherein the header ribbon 119 includes a predetermined application launcher icon cluster 347. Upon selecting in step 330 one of the predetermine application icons 305 from the application icon cluster 347 on the header ribbon 119, the method in step 345 includes displaying a third running application covering the first portion 352, and automatically updating one or more of the second portion 357 in step 350 and the predetermined application icon cluster 347 on the header ribbon 119 in step 355.

Automatically updating the second portion 357 includes displaying a fourth running application responsive to the third running application. The method further includes automatically updating the predetermined application icon cluster 347 with executing at least one or more of de-emphasizing of a predetermined application icon 305, removing a predetermined application icon 305, and introducing an alternative predetermined application icon 305.

The predetermined application icons 305 are displayed in a first sequential order wherein the first sequential order updates to a second sequential order based on a frequency of use.

The fourth running application is responsive to a frequency of operational coupling of the third running and the further running application. The fourth running application is responsive to an operation of the work implement 65.

The display field 116 to be displayed on the display device 115 is user selectable via user interface 117 associated with the display device 115.

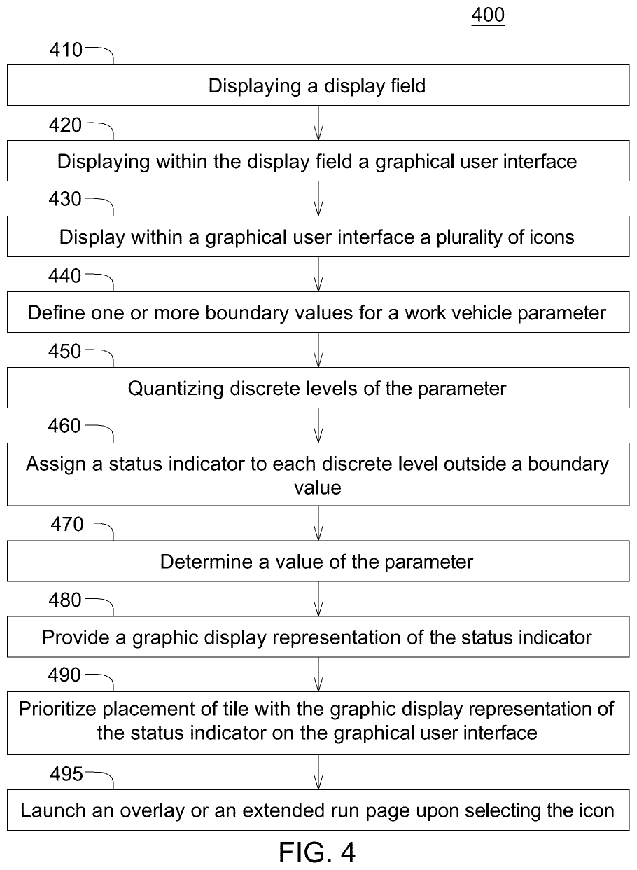

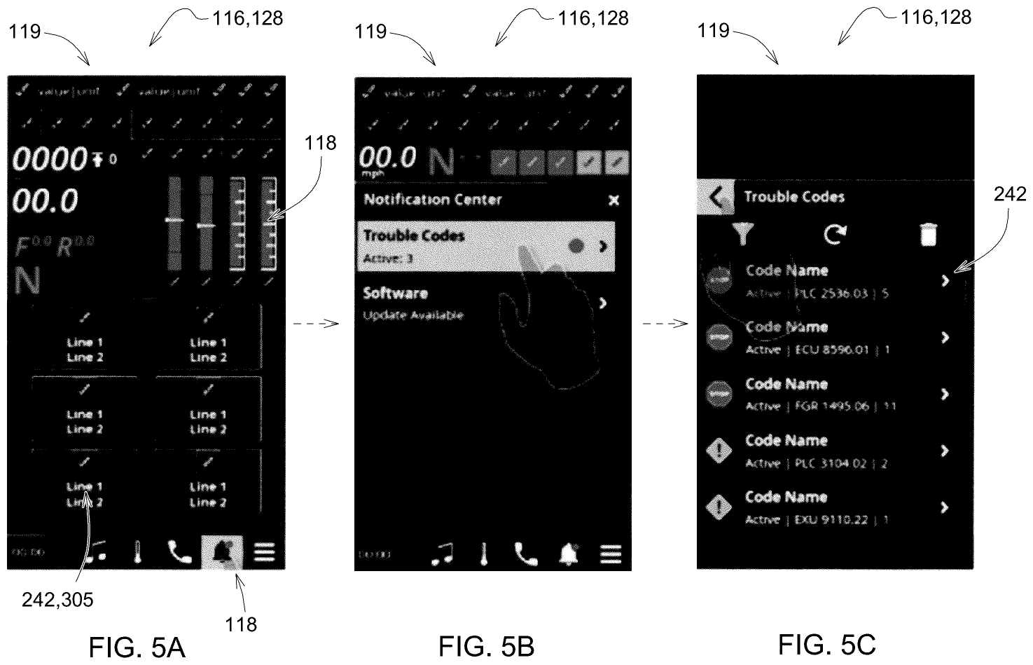

FIG. 4 discloses a method 400 for monitoring and visualizing a plurality of metrics during operation of a work vehicle 60 with an implement 65 and a display device 115 (exemplary formats are shown in FIGS. 5A through 5C). In a first step 410, the method includes displaying a display field 116. In step 420, the method then displays within a display field 116 a graphical user interface 117. In step 430, the method includes display within a graphical user interface 117 a plurality of icons 306 (previously also referred to as application launcher icons).

Next, in step 440, the step includes defining one or more boundary values for a work vehicle parameter. A boundary for a work vehicle 60 parameter refers to a predefined limit or range within which a specific metric or characteristic of the vehicle is expected to operate. Boundaries typically are set to ensure safe and efficient operation, as well as to monitor and control various aspects of the vehicle's performance. A few examples of boundaries that can be set for a wide range of parameters include, but is not limited to, temperature, speed, load capacity, energy consumption, engine rpm, and emissions. Next, in step 450 the method then quantizes discrete levels of the parameter. Quantizing discrete levels of a boundary involves dividing a continuous range of values into distinct, discrete levels or categories. When quantizing discrete levels of a boundary for a work vehicle parameter, it may involve categorizing the parameter values in predefined ranges or thresholds. For example, engine temperature may be quantized by dividing the temperature range into categories such as “normal”, “elevated” and “overheating.” In a context of vehicle monitoring and control systems, quantizing discrete levels of boundaries allow for a streamlined interpretation of data, setting of alarm or triggers, and implementation of automated responses based on the categorized parameter values. This can assist operators and maintenance personnel to quickly identify when a parameter exceeds its acceptable range and triggering appropriate actions and/or notifications to address potential issues and maintain the vehicles safe and efficient operations. Quantizing discrete levels of boundary simplifies the monitoring an management of vehicle parameters by organizing real-time data into distinct levels, enabling a clearing interpretation and effective control and decision-making.

FIGS. 5A-5C show sequential display fields 116 when a status indicator 118 alerts an operator and the operator selects the status indicator 118 which also serves as an application launcher icon 305 to display troubles codes, error codes, or updates (shown in FIG. 5B) and listing them by priority as seen in FIG. 6.

In step 460, the method includes assigning a status indicator 118 to each discrete level outside a boundary value. In step 470, the method includes determining a value of the parameter. Based on this value of the parameter, the method then includes providing a graphic display representation of the status indicator 118 in step 480. In step 490, the method involves prioritizing placement of the tile 242 with the graphic display representation of the status indicator 118 on the graphical user interface 117 (e.g. as seen in FIG. 2). The method 400 then launches an overlay or an extended run page upon selecting the icon 242 in step 495.

Thus, it is seen that an apparatus and/or methods according to the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments, unless otherwise specifically stated.

What is claimed is:

1. A method of monitoring the operation of a work vehicle having a work implement and a display device, the method comprising:
displaying on the display device a display field;
displaying within the display field a graphical user interface including an application launcher icon;
launching a run page within the graphical user interface upon selecting the application launcher icon;
displaying within the run page a first overlay, a second overlay, and a header ribbon,
wherein the first overlay covers a first portion of the run page and includes a first currently running vehicle application,
wherein the second overlay covers a second portion of the run page and includes a second currently running vehicle application,
wherein the header ribbon is positioned adjacent to one or more of the first overlay and the second overlay, the header ribbon including a predetermined application icon cluster; and
upon selection of one of a predetermined application icon from predetermined application icon cluster, displaying a third running application covering the first section, and automatically updating one or more of the second section and the predetermined application icon cluster.

2. The method of claim 1, wherein:
automatically updating the second section includes displaying a fourth running application responsive to the third running application.

3. The method of claim 1, wherein:
automatically updating the predetermined application icon cluster with executing at least one or more of de-emphasizing the predetermined application icon, removing the predetermined application icon, and introducing an alternative predetermined application icon.

4. The method of claim 1, wherein:
the predetermined application icons are displayed in a first sequential order, the first sequential order updating to a second sequential order based on a frequency of use.

5. The method of claim 2, wherein:
the fourth running application is responsive to a frequency of operational coupling of the third running and the fourth running application.

6. The method of claim 2, wherein:
wherein the fourth running application is responsive to an operation of the work implement.

7. The method of claim 2, wherein the display field to be displayed on the display device is user selectable via a user interface associated with the display device.

8. A system for controlling a display during the operation of a work vehicle having a work implement comprising:
a user interface including a touch screen display;
a control module operatively connected to the user interface and to the work implement, wherein the control module includes a processor and a memory, wherein the memory is configured to store program instructions and the processor is configured to execute the stored program instructions to:
display on the touch screen display a display field;
displaying within the display field a graphical user interface including an application launcher icon;
launching a run page within the graphical user interface upon selecting the application launcher icon;
displaying within the run page a first overlay, a second overlay, and a header ribbon upon selection of the application launcher icon by a user,
wherein the first overlay covers a first portion of the run page and includes a first currently running vehicle application,
wherein the second overlay covers a second portion of the run page and includes a second currently running vehicle application,
wherein the header ribbon is positioned adjacent to one or more of the first overlay and the second overlay, the header ribbon including a predetermined application icon cluster; and
upon selection of one of a predetermined application icons from the predetermined application icon cluster, displaying a third running application covering the first section of the run page, and automatically updating one or more of the second section of the run page and the predetermined application icon cluster.

9. The system of claim 8, wherein the processor is configured to execute the stored programs instructions to:
automatically update the second section of the run page by displaying a fourth running application responsive to the third running application.

10. The system of claim 8, wherein the processor is configured to execute the stored programs instructions to:
automatically update the predetermined application icon cluster by one or more of de-emphasizing the predetermined application icon, removing the predetermined application icon, and introducing an alternative predetermined application icon.

11. The system of claim 8, wherein the processor is configured to execute the stored programs instructions to:
automatically display the predetermined application icons in a first sequential order, the first sequential order updating to a second sequential order based on a frequency of use.

12. The system of claim 9, wherein the fourth running application is responsive to a frequency of operational coupling of the third running application and the fourth running application.

13. The system of claim 9, wherein the fourth running application is responsive to an operation of the work implement.

14. A method for monitoring and visualizing a plurality of metrics during operation of a work vehicle having an implement and a display device, the method comprising:
displaying on the display device a display field;
displaying within the display field a graphical user interface;
displaying within the graphical user interface a plurality of icons, each of the icons corresponding to a parameter during operation of the work vehicle;
defining one or more boundary values for each parameter;
quantizing discrete levels of the parameter;
assigning a status indicator to each discrete level outside a boundary value;
determining a value of the parameter and responsively determining application of the status indicator for each icon;
providing a graphic display representation of the status indicator associated with the icon.

15. The method of claim 14, wherein the graphic display representation comprises modifying one of a color, a shade, a pattern, a shape, and graphic of the icon.

16. The method of claim 14, wherein determining the value of the parameter comprises one of monitoring a sensor signal associated with the parameter, the sensor signal derived from a sensor located on the work vehicle, and interrogating the sensor associated with the parameter, the sensor located on the work vehicle.

17. The method of claim 14, wherein the value comprises one of a descriptive analytic, a diagnostic analytic, a predictive analytic, and a prescriptive analytic.

18. The method according to claim 14, wherein providing the graphic display representation of the status indicator associated with the icon updates the icon automatically.

19. The method according to claim 14, wherein the plurality of icons comprises of a predetermined number of tiles spaced horizontally and vertically.

20. The method according to claim 19 further comprising limiting a number of tiles displayed at one time on the graphical user interface.

21. The method according to claim 19 further comprises prioritizing placement of the tile to display the icon with the graphic display representation of the status indicator on the graphical user interface.

22. The method according to claim 14, further comprises launching an overlay covering a portion of the graphical user interface upon selecting the icon, wherein the overlay displays details of the parameter.
